(19) United States
(12) Patent Application Publication
(10) Pub. No.: US 2017/0178171 A1
(43) Pub. Date: Jun. 22, 2017

(54) SALES MANAGEMENT DEVICE AND SALES MANAGEMENT METHOD OF PREORDERED PRODUCT OR SERVICE

(71) Applicant: NET PILOTING INC., Chuo-ku Tokyo (JP)

(72) Inventor: Koutaro YAMADA, Chuo-ku Tokyo (JP)

(21) Appl. No.: 15/129,492

(22) PCT Filed: Oct. 23, 2014
(86) PCT No.: PCT/JP2014/078279

§ 371 Date: Sep. 27, 2016

(30) Foreign Application Priority Data
Mar. 27, 2014 (JP) 2014-065593

(51) Int. Cl. G06Q 30/02; G06Q 30/06

(52) U.S. Cl. CPC G06Q 30/0223; G06Q 30/0635

(57) ABSTRACT

When a customer is to purchase a product or the like, a “bulk purchase” is accepted as preorder and preorder information including a product code, a purchase condition and the like is registered in a sales management server even if the purchase is not performed at the same time. The sales management server has a structure in which a part corresponding to a remaining preorder quantity subjected to the preorder is managed, preorder information is confirmed in each purchase, and a selling price predetermined as a purchase condition is applied in consideration of a discount caused by the “bulk purchase”. Also in the case in which the same product or service is repeatedly purchased with a purchase time shifted, consequently, it is possible to set a proper discount price taking a profitable line into consideration. It is also possible to employ a structure in which the preorder information is stored in a membership card held by the customer.

### TECHNICAL FIELD

The present invention relates to a sales management device and a sales management method for managing sales of a predetermined number of preordered products or services.

### BACKGROUND ART

As is well known, there has been performed, for a long time, an action for applying a discount to be a so-called “bulk purchase” to a customer who collectively purchases a plurality of same products at the same time or an action for so-called “giving a bonus to a client” which gives a discount for a product to a customer who repeatedly purchases the product. In a store or an online shop for selling a product, currently, a sales situation of a product, a purchase trend of a customer or the like is generally grasped by using a computer system. The technique for managing the sales action is also offered.

For example, referring to the “bulk purchase”, there is disclosed the invention related to a system for applying a discount rate corresponding to the number of products ordered for each group and discounting a unit selling price of a product when the “bulk purchase” is performed as in a product selling server (see Patent Document 1) for calculating a purchase price for each user when purchasing the product in the group.

Referring to “a bonus to be given to a client”, moreover, there are disclosed the invention (see Patent Document 2 and Patent Document 3, for example) related to a system for recording a purchase history of a customer related to a specific product on a server side and applying a kickback or discount of a purchase price depending on the number of purchases and the invention (see Patent Document 4, for example related to a system for applying a discount depending on a period since a last time that the customer purchased the same product.

### PRIOR ART DOCUMENT

### Patent Document

Patent Document 1: Japanese Laid-Open Patent Publication No. 2001-357313
Patent Document 2: Japanese Laid-Open Patent Publication No. 2005-084970
Patent Document 3: Japanese Laid-Open Patent Publication No. 2002-117309
Patent Document 4: Japanese Laid-Open Patent Publication No. 2001-222767

### SUMMARY OF THE INVENTION

### Problems to be Solved

In the case in which a product is sold by utilization of the system, the following is supposed as an object of the “bulk purchase”. More specifically, in respect of a standpoint of a customer to purchase a product, the number of orders to which a discount can be applied is to be ensured on one point of time. There is the following problem. More specifically, if a purchase is performed in a group, it is necessary to collect a participant. If a person performs a bulk purchase by himself (herself), he (she) has to keep, in home or the like, at least a number of products which is required at that time. A food having a consumption time limit or the like becomes a target with difficulty. In addition, there is also a limit that it is impossible to perform application to offer of a service which cannot be kept like a product.

In other words, there is demanded a mechanism capable of presenting an advantageous price for the case in which the same product is “collectively purchased” at the same time, and furthermore, the case in which a purchase time is shifted and the case in which the same product is repeatedly purchased so that they are “collectively purchased”.

Moreover, the following is supposed as an object of “a bonus to be given to a client”. There is a problem in that a bad influence might be exerted on a profit if a discount is continuously performed on an ad hoc basis without predetermination of a rule. Even if a certain discount rule is applied depending on the number of purchases or a purchase frequency by utilization of the system described above, it is impossible to predict which number of products is finally purchased by a customer. For this reason, there is a problem in that it is hard to determine a proper discount price in consideration of a profitable line, for example, a profit is greatly damaged when the purchase is performed more repeatedly than expected if a discount rate is increased or an impact on a customer is lost if the discount rate is reduced to avoid the damage.

In other words, there is demanded a mechanism capable of precisely grasping a total amount for the repeated purchase and setting a proper discount price taking a profitable line into consideration when the discount is applied to the repeated purchase of the same product.

The present invention has been made corresponding to the problems and has an object to provide a sales management device and a sales management method for managing sales of a predetermined number of preordered products or services which can set a proper discount price taking a profitable line into consideration in the case in which the same product or service is repeatedly purchased with a purchase time shifted.

### Means for Solving the Problem

A first invention for attaining the object according to the present application is directed to a sales management device for managing sales of a predetermined amount of preordered products or services with the same product or service set to be a target, the device including storing means for storing preorder information including a customer code for identifying a customer performing preorder, a product code for identifying the preordered product or service, a remaining preorder quantity obtained by subtracting an amount of sales after the preorder from a preorder quantity determined in the preorder of the preordered product or service, and information about a purchase condition for the product or the service to change a selling price every decrease in the remaining preorder quantity in relation to the predetermined amount of preordered products or services with the same product or service set to be the target, receiving means for receiving a request for purchasing a product or a service for which a customer code for identifying a customer and a product code for identifying a product or a service are designated from a terminal device connected through a network, deciding means for retrieving the storing means by setting, as a key, a combination of the customer code and the product code which are designated for the purchase request received by the receiving means and deciding whether sales corresponding to the preorder can be performed based on presence of the preorder having the remaining preorder quantity, transmitting means for determining a selling price or a discount price of the product or the service corresponding to the purchase request in accordance with the purchase condition stored in the storing means and transmitting the selling price or the discount price to the terminal device when it is decided by the deciding means that the sales corresponding to the preorder can be performed, and updating means for updating the remaining preorder quantity included in the preorder information stored in the storing means by subtracting the amount of the product or service decided to be enable sold corresponding to the preorder by the deciding means.

A second invention for solving the problems according to the present application is directed to a sales management device for managing sales of a predetermined amount of preordered products or services with the same product or service set to be a target, the device including storing means for storing preorder information including a customer code for identifying a customer performing preorder, a product code for identifying the preordered product or service, an amount of preorder determined in preorder of the preordered product or service and an amount of sale after the preorder, and information about a purchase condition of the product or the service to change a selling price every decrease in a remaining preorder quantity obtained by subtracting the amount of sales from the amount of preorder in relation to the predetermined amount of preordered products or services with the same product or service set to be the target, receiving means for receiving a request for purchasing a product or a service for which a customer code for identifying a customer and a product code for identifying a product or a service are designated from a terminal device connected through a network, deciding means for retrieving the storing means by setting, as a key, a combination of the customer code and the product code which are designated for the purchase request received by the receiving means and deciding whether sales corresponding to the preorder can be performed based on presence of the preorder having the remaining preorder quantity obtained by subtracting the amount of sales after the preorder from the amount of preorder determined in the preorder, transmitting means for determining a selling price or a discount price of the product or the service corresponding to the purchase request in accordance with the purchase condition stored in the storing means and transmitting the selling price or the discount price to the terminal device when it is decided by the deciding means that the sales corresponding to the preorder can be performed, and updating means for updating the amount of sales after the preorder included in the preorder information stored in the storing means by adding the amount of the products or services decided to be enable sold corresponding to the preorder by the deciding means.

In the present invention, there is employed the structure in which the “bulk purchase” is accepted as the preorder even if the purchase is not performed at the same time, the remaining preorder quantity subjected to the preorder is managed, and a selling price predetermined in consideration of a discount caused by the “bulk purchase” is applied in each purchase when a customer is to purchase a product or the like. Also in the case in which the same product or service is repeatedly purchased with a purchase time shifted, consequently, it is possible to set a proper discount price taking a profitable line into consideration.

The first invention is directed to the structure in which the remaining preorder quantity for the preordered product or the service is stored in the sales management device according to the present invention and a selling price for each time is determined corresponding to the remaining preorder quantity, and the second invention is directed to the structure in which the amount of preorder and the amount of sales for the preordered product or service are stored and a selling price for each time is determined corresponding to the remaining preorder quantity obtained by subtracting the amount of sales from the amount of preorder.

The present invention can also be applied to offer of a service to be repeatedly utilized as well as sales of a product to be repeatedly purchased.

The first invention and the second invention can also be characterized in that a condition for reducing a unit selling price of the product or the service every decrease in the remaining preorder quantity is set to the purchase condition to be stored in the storing means.

With the structure in which the selling price to be determined depending on the remaining preorder quantity is reduced every decrease in the remaining preorder quantity, thus, the price is reduced more when the reserved parts are consumed more for the customer. In addition to becoming incentive for the repeated purchase, therefore, even if the customer cancels the preorder, a seller can ensure a profit without imposing a penalty on the customer because an initial price is set to be high.

The first invention and the second invention can also be characterized in that the preorder information to be stored in the storing means includes information about a purchase time limit that the sales corresponding to the preorder can be performed, and the deciding means decides whether the remaining preorder quantity is present and the sales corresponding to the preorder can be performed based on presence of the preorder without the purchase time limit expired.

With the structure in which the time limit is set to the preorder, thus, the seller side can easily make supply planning or sales prediction of a product for a predetermined period. Consequently, the structure is suitable for stock management or profit management.

The first invention and the second invention can also be characterized in that the storing means stores, as the purchase condition included in the preorder information, information to be a key for specifying a selling price or a discount price to be determined for each remaining preorder quantity in relation to a product or a service to be specified by a product code stored in a predetermined storing unit. Alternatively, the first invention and the second invention may be characterized in that the storing means stores, as a purchase condition included in the preorder information, a selling price or a discount price of a product or a service to be determined for each remaining preorder quantity.

In the first invention and the second invention, there is not particularly restricted a form for storing the information about the purchase condition for the product or the service to change a selling price every decrease in the remaining preorder quantity. In the former case, a common purchase condition can be managed unitarily. Therefore, the structure contributes to efficient management of the purchase condition or efficient utilization of a system resource. In the latter case, individual purchase conditions can be immediately specified in acceptance of a purchase request. Therefore, the structure contributes to an enhancement in the efficiency of the processing for the purchase request.

Moreover, the present invention can also be specified as a sales management method to be executed by the sales management device according to the first invention and the second invention.

The sales management method corresponding to the first invention is a sales management method for managing sales of a predetermined amount of preordered products or services with the same product or service set to be a target, a computer having storing means for storing preorder information including a customer code for identifying a customer performing preorder, a product code for identifying a preordered product or a service, a remaining preorder quantity obtained by subtracting an amount of sales after the preorder from an amount of preorder determined in the preorder of the preordered product or service, and information about a purchase condition for the product or the service to change a selling price every decrease in the remaining preorder quantity in relation to the predetermined amount of preordered products or services with the same product or service set to be the target, the method including a receiving step of causing the computer to receive a request for purchasing a product or a service for which a customer code for identifying a customer and a product code for identifying a product or a service are designated from a terminal device connected through a network, a deciding step of causing the computer to retrieve the storing means by setting, as a key, a combination of the customer code and the product code which are designated for the purchase request received at the receiving step and to decide whether sales corresponding to the preorder can be performed based on presence of the preorder having the remaining preorder quantity, a transmitting step of causing the computer to determine a selling price or a discount price of the product or the service corresponding to the purchase request in accordance with the purchase condition stored in the storing means and to transmit the selling price or the discount price to the terminal device when it is decided at the deciding step that the sales corresponding to the preorder can be performed, and an updating step of causing the computer to update the remaining preorder quantity included in the preorder information stored in the storing means by subtracting the amount of the products or services decided to be enable sold corresponding to the preorder at the deciding step.

The sales management method corresponding to the second invention is a sales management method for managing sales of a predetermined amount of preordered products or services with the same product or service set to be a target, a computer having storing means for storing preorder information including a customer code for identifying a customer performing preorder, a product code for identifying a preordered product or service, an amount of preorder determined in the preorder of the preordered product or service and an amount of sales after the preorder, and information about a purchase condition of the product or the service to change a selling price every decrease in a remaining preorder quantity obtained by subtracting the amount of sales from the amount of preorder in relation to the predetermined amount of preordered products or services with the same product or service set to be the target, the method including a receiving step of causing the computer to receive a request for purchasing a product or a service for which a customer code for identifying a customer and a product code for identifying a product or a service are designated from a terminal device connected through a network, a deciding step of causing the computer to retrieve the storing means by setting, as a key, a combination of the customer code and the product code which are designated for the purchase request received at the receiving step and to decide whether sales corresponding to the preorder can be performed based on presence of the preorder having the remaining preorder quantity obtained by subtracting the amount of sales after the preorder from the amount of preorder determined in the preorder, a transmitting step of causing the computer to determine a selling price or a discount price of the product or the service corresponding to the purchase request in accordance with the purchase condition stored in the storing means and to transmit the selling price or the discount price to the terminal device when it is decided at the deciding step that the sales corresponding to the preorder can be performed, and an updating step of causing the computer to update the amount of sales after the preorder included in the preorder information stored in the storing means by adding the amount of the products or services decided to be enable sold corresponding to the preorder at the deciding step.

Moreover, the sales management methods corresponding to the first invention and the second invention can also be specified as sales management methods to be executed corresponding to the respective structures of the sales management devices according to the first invention and the second invention.

A third invention for attaining the object is directed to a sales management device for managing sales of a predetermined amount of preordered products or services with the same product or service set to be a target, the device including accepting means for accepting a product code for identifying a product or a service to be purchased by a customer, deciding means for retrieving information stored in a storing unit of a storing medium for storing preorder information including a product code for identifying a preordered product or service, a remaining preorder quantity obtained by subtracting an amount of sales after the preorder from an amount of preorder determined in the preorder of the preordered product or service, and information about a purchase condition for the product or the service to change a selling price every decrease in the remaining preorder quantity and deciding whether sales corresponding to the preorder can be performed based on presence of the preorder having the remaining preorder quantity in relation to the predetermined amount of preordered products or services with the same product or service set to be the target by setting the product code accepted by the accepting means as a key, determining means for determining a selling price or a discount price of a product or a service to be purchased by the customer in accordance with the purchase condition stored in the storing unit when it is decided by the deciding means that the sales corresponding to the preorder can be performed, and updating means for updating the remaining preorder quantity included in the preorder information stored in the storing unit by subtracting the amount of the products or services decided to be enable sold corresponding to the preorder by the deciding means.

A fourth invention for attaining the object is directed to a sales management device for managing sales of a predetermined amount of preordered products or services with the same product or service set to be a target, the device including accepting means for accepting a product code for identifying a product or a service to be purchased by a customer, deciding means for retrieving information stored in a storing unit of a storing medium for storing preorder information including a product code for identifying a preordered product or service, an amount of preorder determined in the preorder of the preordered product or service and an amount of sales after the preorder, and information about a purchase condition of the product or the service to change a selling price every decrease in a remaining preorder quantity obtained by subtracting the amount of sales from the amount of preorder and deciding whether sales corresponding to the preorder can be performed based on presence of the preorder having the remaining preorder quantity in relation to the predetermined amount of preordered products or services with the same product or service set to be the target by setting the product code accepted by the accepting means as a key, determining means for determining a selling price or a discount price of a product or a service to be purchased by the customer in accordance with the purchase condition stored in the storing unit when it is decided by the deciding means that the sales corresponding to the preorder can be performed, and updating means for updating the amount of sales after the preorder included in the preorder information stored in the storing unit by adding the amount of the products or services decided to be enable sold corresponding to the preorder by the deciding means.

In the first invention and the second invention, the remaining preorder quantity subjected to the preorder and the like are collectively managed on the server side. In contrast, in the third invention and the fourth invention, there is employed the structure in which the information about the “bulk purchase” such as the remaining preorder quantity subjected to the preorder is stored in a storing medium such as an IC card held by each customer.

In the same manner as the first invention, the sales management device according to the third invention has the structure in which the remaining preorder quantity for the preordered product or service is stored and a selling price for each time is determined corresponding to the remaining preorder quantity. In the same manner as the second invention, the fourth invention has the structure in which the remaining preorder quantity and the amount of sales for the preordered product or service is stored and a selling price for each time is determined corresponding to the remaining preorder quantity obtained by subtracting the amount of sales from the amount of preorder.

The third invention and the fourth invention can also be characterized in that a condition for reducing a unit selling price of the product or the service every decrease in the remaining preorder quantity is set to the purchase condition to be stored in the storing means.

The third invention and the fourth invention can also be characterized in that the preorder information to be stored in the storing means includes information about a purchase time limit that the sales corresponding to the preorder can be performed, and the deciding means decides whether the sales corresponding to the preorder can be performed based on presence of the remaining preorder quantity and presence of the preorder without the purchase time limit expired.

The third invention and the fourth invention can also be characterized in that the storing means stores, as a purchase condition included in the preorder information, a selling price or a discount price of a product or a service to be determined for each remaining preorder quantity.

Moreover, the present invention can also be specified as a sales management method to be executed by the sales management devices according to the third invention and the fourth invention.

The sales management method corresponding to the third invention is directed to a sales management method to be executed by a sales management device for managing sales of a predetermined amount of preordered products or services with the same product or service set to be a target, the method including an accepting step of causing the sales management device to accept a product code for identifying a product or a service to be purchased by a customer, a deciding step of causing the sales management device to retrieve information stored in a storing unit of a storing medium for storing preorder information including a product code for identifying a preordered product or service, a remaining preorder quantity obtained by subtracting an amount of sales after the preorder from an amount of preorder determined in the preorder of the preordered product or service, and information about a purchase condition for the product or the service to change a selling price every decrease in the remaining preorder quantity and deciding whether sales corresponding to the preorder can be performed based on presence of the preorder having the remaining preorder quantity in relation to the predetermined amount of preordered products or services with the same product or service set to be the target by setting, as a key, the product code accepted at the step, a determining step for causing the sales management device to determine a selling price or a discount price of a product or a service to be purchased by the customer in accordance with the purchase condition stored in the storing unit when it is decided at the deciding step that the sales corresponding to the preorder can be performed, and an updating step of causing the sales management device to update the remaining preorder quantity included in the preorder information stored in the storing unit by subtracting the amount of the products or services decided to be enable sold corresponding to the preorder at the deciding step.

The sales management method corresponding to the fourth invention is directed to a sales management method to be executed by a sales management device for managing sales of a predetermined amount of preordered products or services with the same product or service set to be a target, the method including an accepting step of causing the sales management device to accept a product code for identifying a product or a service to be purchased by a customer, a deciding step of causing the sales management device to retrieve information stored in a storing unit of a storing medium for storing preorder information including a product code for identifying a preordered product or service, an amount of preorder determined in the preorder of the preordered product or service and an amount of sales after the preorder, and information about a purchase condition for the product or service to change a selling price every decrease in a remaining preorder quantity obtained by subtracting the amount of sales from the amount of preorder and deciding whether sales corresponding to the preorder can be performed based on presence of the preorder having the remaining preorder quantity in relation to the predetermined amount of preordered products or services with the same product or service set to be the target by setting, as a key, the product code accepted at the step, a determining step of causing the sales management device to determine a selling price or a discount price of a product or a service to be purchased by the customer in accordance with the purchase condition stored in the storing unit when it is decided at the deciding step that the sales corresponding to the preorder can be performed, and an updating step of causing the sales management device to update the amount of sales after the preorder included in the preorder information stored in the storing unit by adding the amount of the products or services decided to be enable sold corresponding to the preorder by the deciding means.

Moreover, the sales management methods corresponding to the third invention and the fourth invention can also be specified as sales management methods to be executed corresponding to the respective structures of the sales management devices according to the third invention and the fourth invention.

### Effect of the Invention

According to the present invention, in the case in which the same product or service is repeatedly purchased with a purchase time shifted, it is possible to manage the repeated purchase as a predetermined amount of preorder and to set a proper discount price taking a profitable line into consideration. Also in the case in which a customer purchases a part of the preorder amount and then cancels the preorder, moreover, it is possible to set a discount price which is advantageous to both the customer and a seller. Consequently, it is possible to provide a sales method for a new product or the like, thereby expecting contribution to revitalization of commercial business.

### BRIEF DESCRIPTION OF THE DRAWINGS

FIG. 1 is a view showing a summary of a first embodiment according to the present invention.

FIG. 2 is a view showing a summary of a second embodiment according to the present invention.

FIG. 3 is a diagram showing an example of price setting for a “bulk purchase” according to the present invention.

FIG. 4 is a block diagram showing an example of a structure according to the first embodiment of the present invention.

FIG. 5 is a first diagram showing an example of a flow of the “bulk purchase” according to the first embodiment of the present invention.

FIG. 6 is a second diagram showing the example of the flow of the “bulk purchase” according to the first embodiment of the present invention.

FIG. 7 is a third diagram showing the example of the flow of the “bulk purchase” according to the first embodiment of the present invention.

FIG. 8 is a fourth diagram showing the example of the flow of the “bulk purchase” according to the first embodiment of the present invention.

FIG. 9 is a first flowchart showing a flow for processing the “bulk purchase” according to the present invention.

FIG. 10 is a second flowchart showing the flow for processing the “bulk purchase” according to the present invention.

FIG. 11 is a third flowchart showing the flow for processing the “bulk purchase” according to the present invention.

FIG. 12 is a block diagram showing an example of a structure according to a third embodiment of the present invention.

### MODE FOR CARRYING OUT THE INVENTION

A mode for carrying out the present invention will be described below in detail with reference to the drawings. Although description will be given to an example in which the present invention is mainly applied to sales of a product in a store, the present invention is not restricted to the embodiment but it is possible to apply to offer of a service to be repeatedly utilized as well as sales of a product and to apply to an online shop on internet in place of a real store.

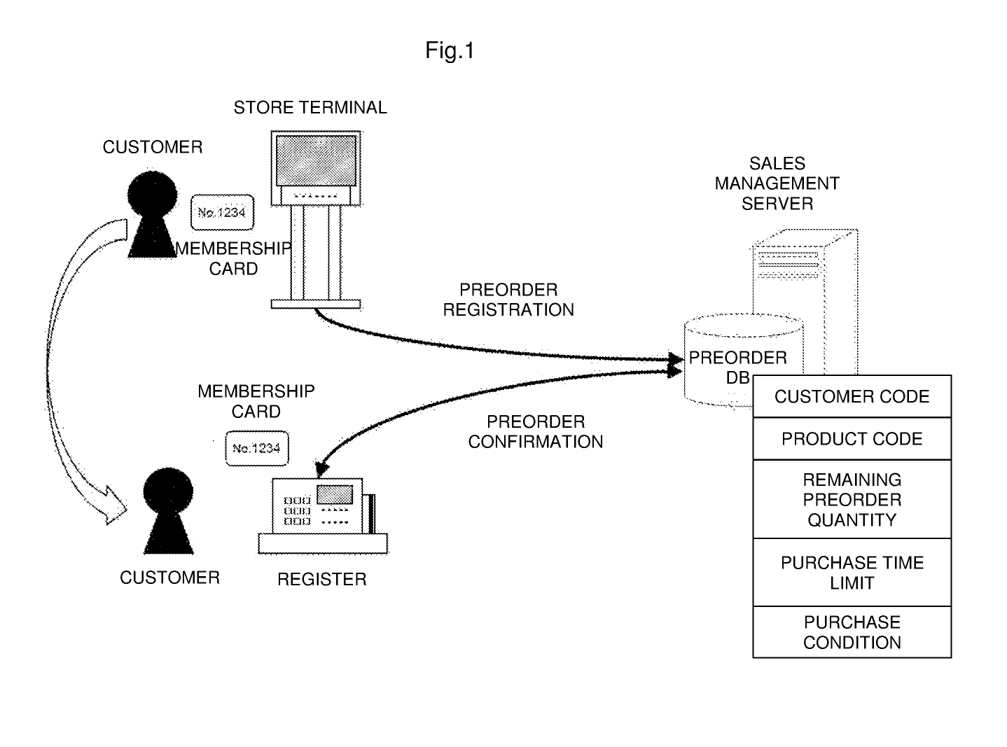

FIG. 1 shows a summary of a first embodiment in which the present invention is applied to sales of a product in a real store. When a customer visits the store and inserts a membership card issued by the store into a KIOSK terminal provided in the store, a customer code such as a membership number for identifying the customer is transmitted to a sales management server corresponding to the sales management device according to the present invention. In the sales management server, a product recommended for a customer is selected and information about the recommended product is transmitted and displayed on the KIOSK terminal. If a product which can be “collectively purchased”, that is, can be purchased in a predetermined number for a certain period is relevant, a purchase condition for the “bulk purchase” is displayed together.

When the customer performs an operation for selecting the “bulk purchase” through the KIOSK terminal, information about contents of the “bulk purchase” including a product code such as a JAN code for identifying a product and the like is transmitted to the sales management server and is registered as preorder information in a database. The preorder information to be registered in the database includes information about purchase conditions, for example, a customer code, a product code, a remaining preorder quantity (an amount of preorder at a time of the preorder), a purchase time limit corresponding to preorder, a selling price of a product to be determined depending on the remaining preorder quantity and the like.

If the customer presents a membership card and a reserved product at a register in the store when purchasing the product, a customer code and a product code are transmitted to the sales management server so that the database is retrieved to confirm presence of the preorder. In the case in which there are a remaining preorder quantity and preorder that has not expired a purchase time limit, it is decided that the purchase for the preorder can be performed so that a selling price corresponding to the remaining preorder quantity to be determined based on the purchase conditions (which may be a discount price with respect to a regular price) is returned to the register.

Herein, the selling price of the product to be determined depending on the remaining preorder quantity to be defined as the purchase condition is set to fluctuate every time the remaining preorder quantity is decreased. Consequently, a product seller can individually perform such price setting as to be incentive for the customer to repeatedly purchase the same product while ensuring a proper profit.

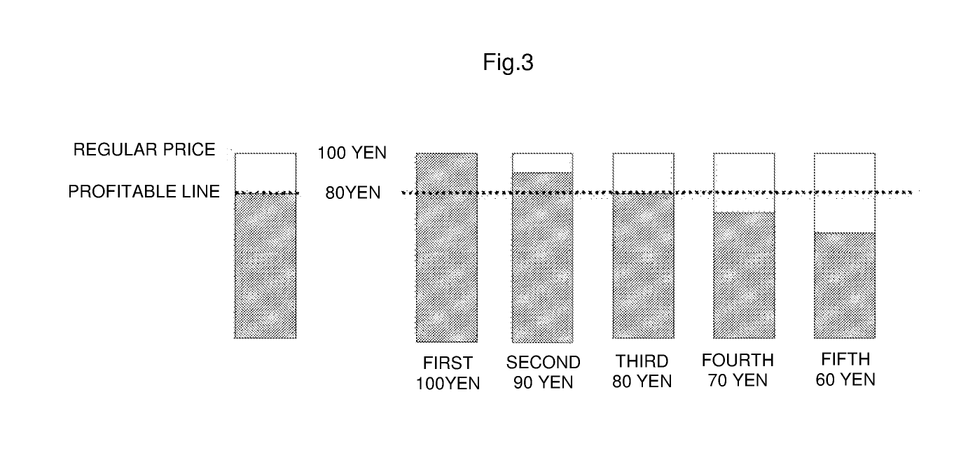

How to perform the price setting is not particularly restricted (for example, it is also possible to perform such price setting that only a first product is set into a regular price and subsequent products are set into an equal discount price or a predetermined number of products are sold at a regular price and products are then free of charge in and after a certain stage). As shown in an example of FIG. 3, however, when setting is performed in such a manner that the unit selling price of the product is reduced every decrease in the remaining preorder quantity, there are an advantage that a total purchase price can be reduced by a “bulk purchase” at a customer side, and furthermore, the price is more reduced with an increase in the number of purchases, and an advantage that it is possible to maintain a profitable line without requesting a penalty to a customer even if the customer cancels a reserved part in the middle. Therefore, the setting is suitable for both of them.

Although preorder is registered through the KIOSK terminal provided in the store and confirmation of the preorder in a purchase is performed through the register in FIG. 1, the present invention is not restricted to the embodiment but it is also possible to confirm the preorder in the purchase of a product through the KIOSK terminal and to output a coupon ticket having a selling price for each time (which may be a discount price with respect to a regular price) and to present the coupon ticket at the register, and to the contrary, to employ a structure in which the preorder can be registered at the register in a first purchase, for example.

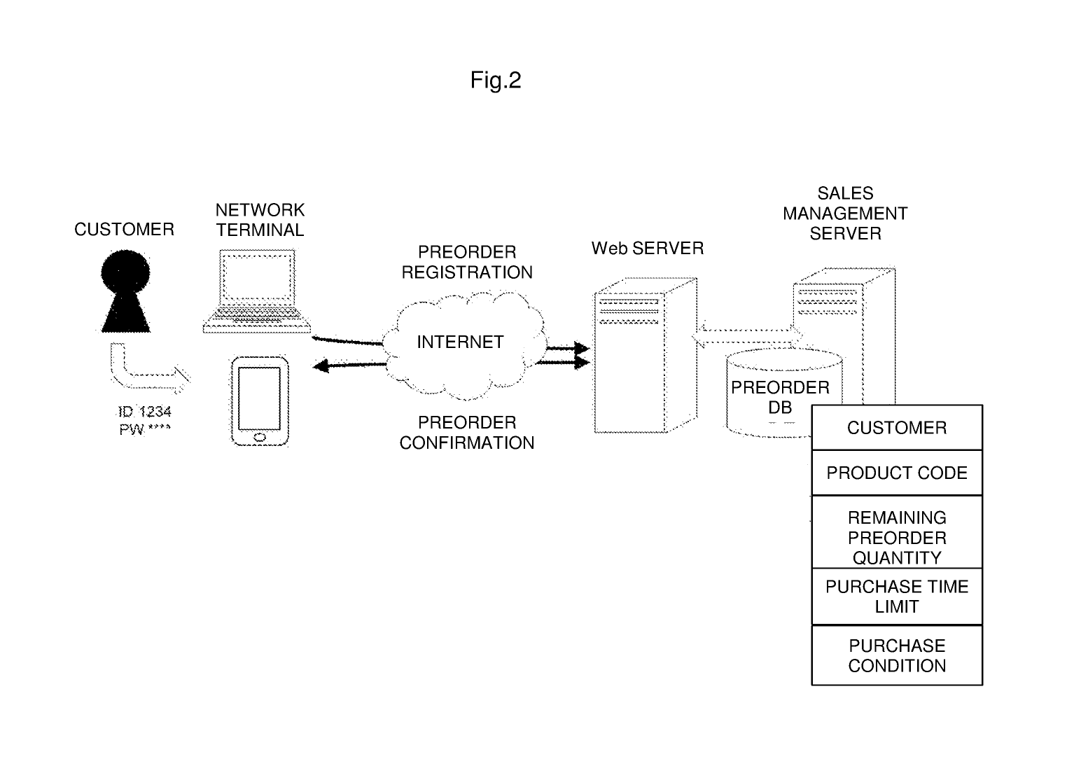

FIG. 2 shows a summary of a second embodiment in which the present invention is applied to an online shop on internet. Although a structure on a sales management server side is the same as that in the first embodiment, both registration of preorder for a “bulk purchase” and confirmation of the preorder in a purchase are performed through a network terminal such as a PC or a smartphone which is to be operated by a customer.

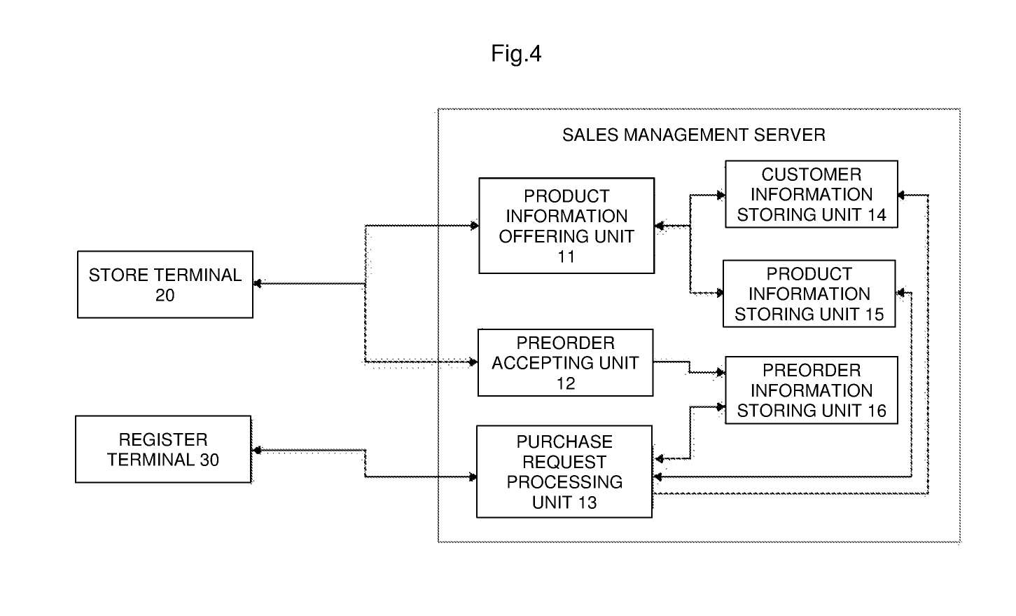

FIG. 4 shows an example of a system structure for carrying out the present invention according to the first embodiment. A sales management server 10 in FIG. 4 corresponds to the sales management device according to the present invention.

The sales management server 10 is a computer including an auxiliary storage device such as a CPU, a main memory and an HDD, and a program stored in the auxiliary storage device is read onto the main memory and a calculation processing is executed by the CPU so that a predetermined function is implemented.

A physical structure of the computer configuring the sales management server 10 is not particularly restricted but functions other than the functions related to the registration and confirmation of the preorder to be used in the present invention may be provided in the same computer. Each of the functions required for the present invention may be physically implemented by a single computer or a plurality of computers.

All of a product information offering unit 11, a preorder accepting unit 12 and a purchase request processing unit 13 in the sales management server 10 are specified functionally. A program corresponding to the function of each portion stored in the auxiliary storage device such as the HDD is read onto the main memory and the calculation processing is executed by the CPU so that a function corresponding to each portion is implemented.

Predetermined storage regions of the auxiliary storage device such as the HDD are assigned to a customer information storing unit 14, a product information storing unit 15 and a preorder information storing unit 16 in the sales management server 10, respectively. These storage regions are not required to be physically provided in a single computer but may be provided in a plurality of computers including a computer configuring a database server or the like.

The KIOSK terminal or the like is used for a store terminal 20. If the KIOSK terminal or the like can perform a data communication with the sales management server 10 together with a register terminal 30, the structure is not particularly restricted. In the second embodiment, these terminals are exchanged with network terminals, for example, a PC, a smartphone and the like which can be connected to internet.

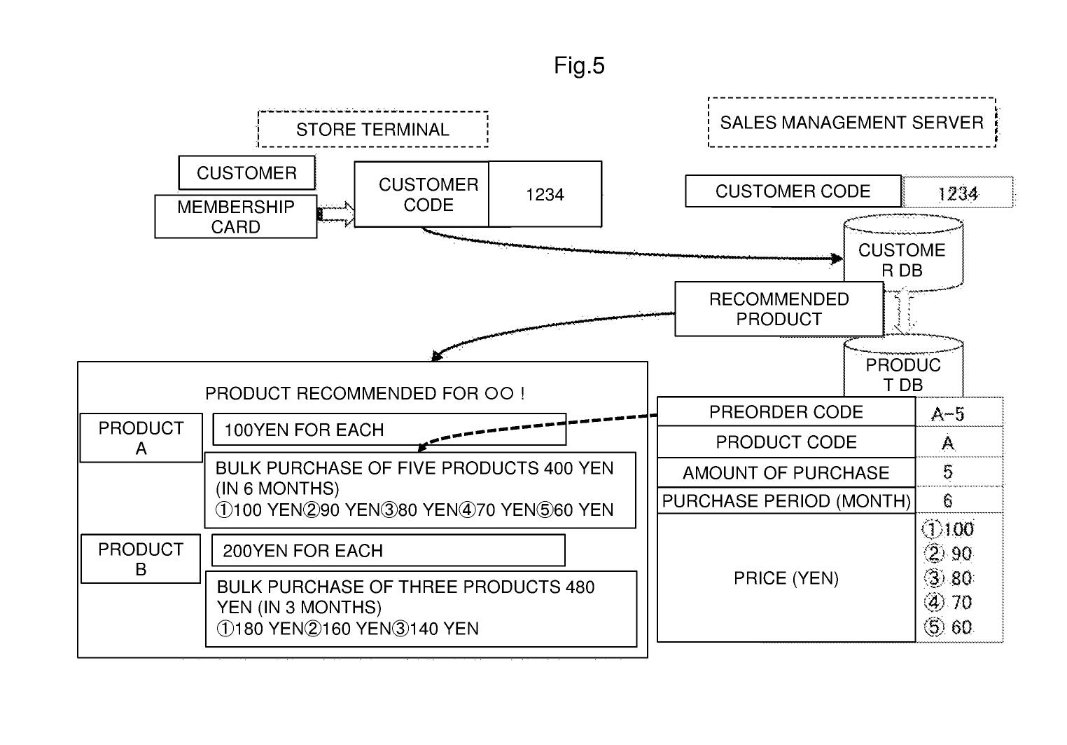

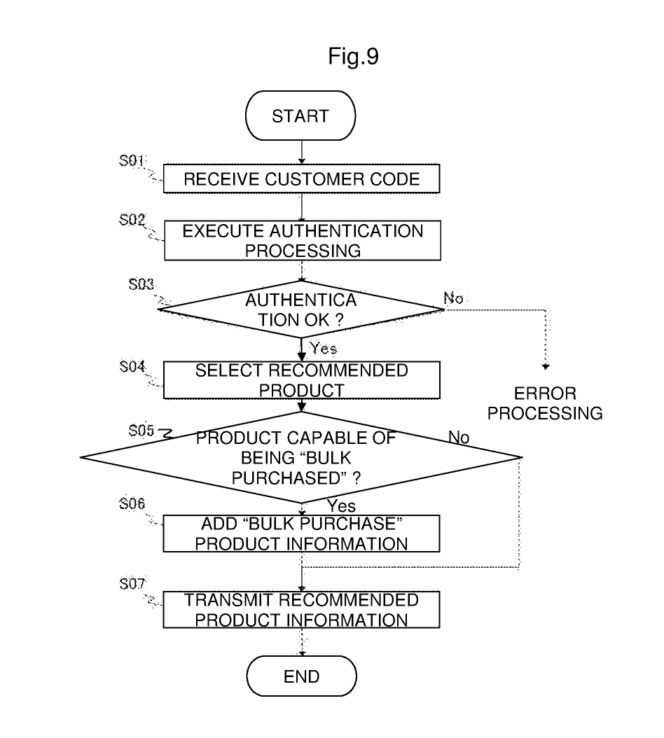

On the assumption of the structure described above, a processing flow for registering preorder information and a processing flow for returning a selling price or a discount price to a purchase request using the present invention will be described in the first embodiment with reference to FIGS. 5 to 8 and flowcharts of FIGS. 9 to 11.

FIG. 5 shows a flow for displaying information about a product which can be “collectively purchased” in the present invention. When a customer inserts a membership card into the store terminal 20, a customer code for identifying the customer which is read from the membership card is transmitted from the store terminal 20 to the sales management server 10. A method of transmitting the customer code is not restricted to this method but it is also possible to employ a method for the customer to operate and input the store terminal 20, a method of performing reading in non-contact through a smartphone held by the customer, or the like, for example.

In the sales management server 10 receiving the customer code, the product information offering unit 11 is activated to execute the processing shown in the flowchart of FIG. 9. When the customer code transmitted from the store terminal 20 is received (S01), the customer information storing unit 14 (the customer database) is retrieved to execute an authentication processing for the customer (S02). A customer authenticating method is not particularly restricted but it is also possible to set, to a requirement for authentication, a request for a customer to input a password to make coincidence with a password registered previously in the customer information storing unit 14 (the customer database) or to make a decision of authentication OK based on the fact that the password is registered as a valid customer code in the customer information storing unit 14 (the customer database).

If the authentication of the customer cannot be performed, the processing is determined to be an error. If the authentication of the customer is performed (S03), a product recommended for the customer is selected by properly referring to the product information storing unit 15 (the product database) based on a predetermined rule setting, as a target, a past purchase history, attribute or the like of the customer (S04). A logic of the recommend to be used herein is not particularly restricted but it is sufficient to employ a recommend engine to be used in recommendation of a product which is adapted to a preference of the customer generally.

Referring to the recommended products which are selected, a screen file for displaying them on a display of the store terminal is generated. If a product which can be “collectively purchased” is included therein (S05), a screen file for recommended product information including information about the product which can be “collectively purchased” is generated (S06) and is transmitted to the store terminal 20 (S07).

Although FIG. 5 shows an example of the screen to be displayed on the store terminal 20, a product A with a regular price of 100 YEN can be “collectively purchased”, that is, five products A can be purchased in six months, and there is displayed a purchase condition that the price is reduced stepwise corresponding to the remaining preorder quantity, that is, the price is 100 YEN for a first product and is 90 YEN for a second product. Referring to a product B, similarly, there is displayed a purchase condition in the case of the “bulk purchase” in which a purchase period and the number of products are designated.

It is sufficient to store, in the product information storing unit 15 (the product database), a pattern of the purchase condition that each product can be “collectively purchased”. In FIG. 5, the pattern of the purchase condition of the “bulk purchase” to be displayed for the product A can be specified by a code for identifying the purchase condition assigned every pattern of the purchase condition (herein “A−5” of the “preorder code”).

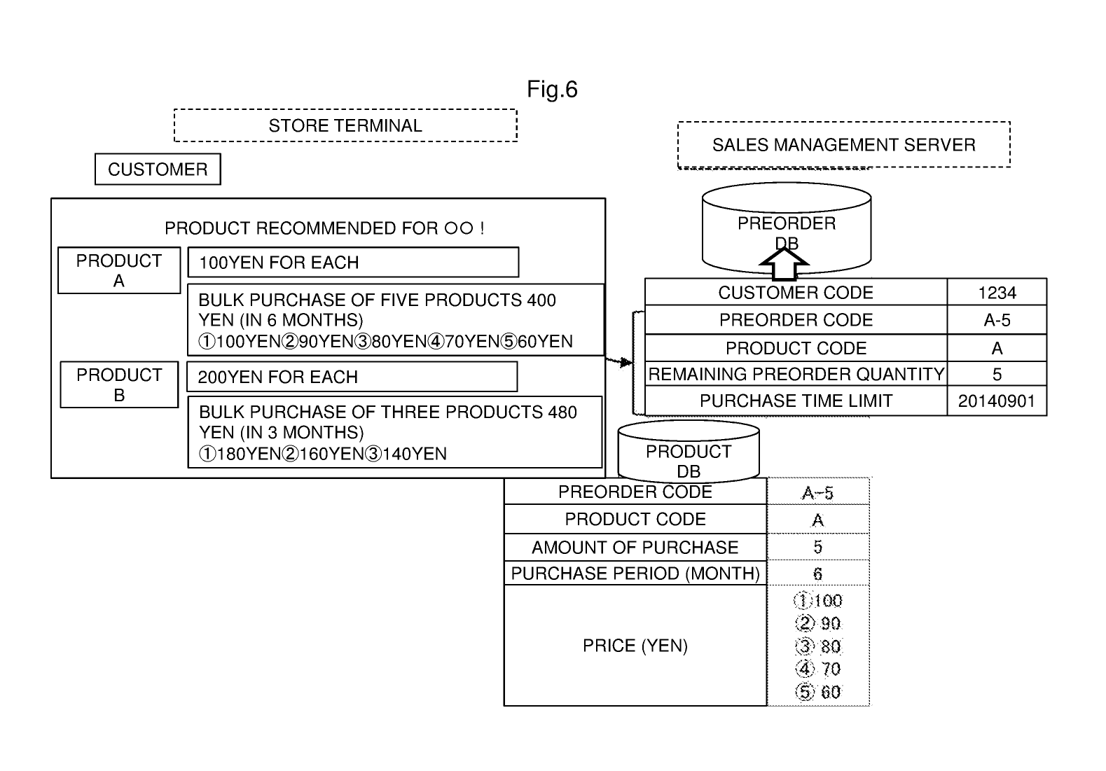

FIG. 6 shows a flow from a state in which information about a product capable of being “collectively purchased” is displayed to a state in which the customer desires the “bulk purchase” and preorder information about the product is registered in the server side in FIG. 5. It is assumed that the customer desires the “bulk purchase” to purchase five products A in six months based on the information about a recommended product displayed on the display of the store terminal 20 and performs a selecting operation on the display. Consequently, information indicating that the purchase condition of the “bulk purchase” is selected is transmitted to the sales management server 10. How to specify the purchase condition of the “bulk purchase” is not particularly restricted but it is preferable to use the preorder code for identifying the purchase condition, for example.

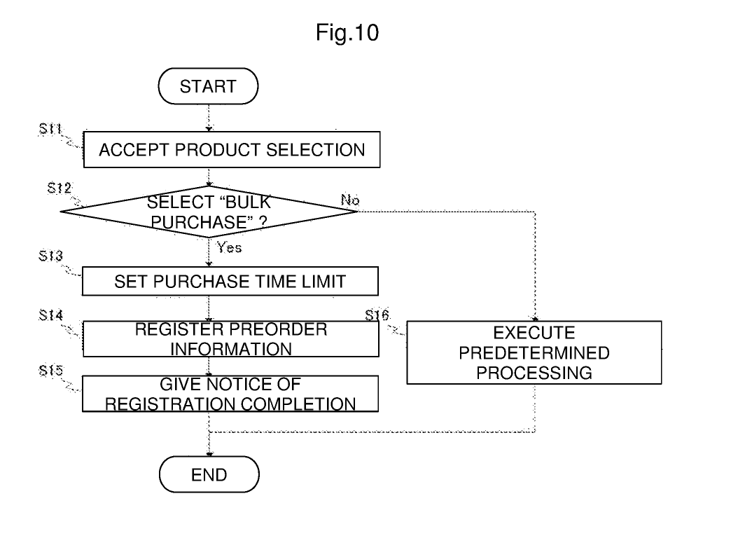

Including the case in which the “bulk purchase” is selected, in the sales management server 10 accepting the selection of a product that the customer wants to purchase, the preorder accepting unit 12 is activated so that the processing shown in the flowchart of FIG. 10 is executed. If the information about the selected product (the preorder code for identifying the purchase condition of the “bulk purchase” in the case of the “bulk purchase” or the like) is accepted through the store terminal 20 (S11), it is decided through the preorder code or the like whether a product selected and desired to be purchased by the customer is relevant to the “bulk purchase” (S12). If the product is not relevant to the “bulk purchase”, there is executed a predetermined processing such as issuance of a coupon ticket which can be used for a discount in the purchase of the product (S16).

If the product is relevant to the “bulk purchase”, a time that a period for which the purchase through the “bulk purchase” can be performed after the preorder passes is set to be a purchase time limit (S13). The preorder information including the preorder code for identifying the purchase condition of the “bulk purchase”, the customer code for identifying a customer making the preorder, the product code for identifying a product subjected to the preorder and the remaining preorder quantity (the initial amount of preorder at a time of the preorder) in addition to the set purchase time limit is registered as new preorder information in the preorder information storing unit 16 (the preorder database) (S14). Moreover, a notice that the preorder is completely registered is given to the store terminal 20 (S15) and is displayed on the display of the store terminal 20.

FIG. 6 shows an example in which new preorder information is registered in the preorder information storing unit 16 (a preorder database). Moreover, a purchase condition for each pattern of the “bulk purchase” including the selling price corresponding to the remaining preorder quantity is stored in the product information storing unit 15 (the product database). In both of them, a preorder code (“A−5” in this example) for identifying the purchase condition of the “bulk purchase” is related to a key. Therefore, a purchase condition corresponding to each preorder information stored in the preorder information storing unit 16 (the preorder database) can be specified by retrieval of the product information storing unit 15 (the product database) with the preorder code set to be the key.

However, a method for specifying the purchase condition corresponding to each preorder information is not restricted to the example using the preorder code described herein. For example, each preorder information to be stored in the preorder information storing unit 16 (the preorder database) may include a purchase condition such as a selling price corresponding to the remaining preorder quantity.

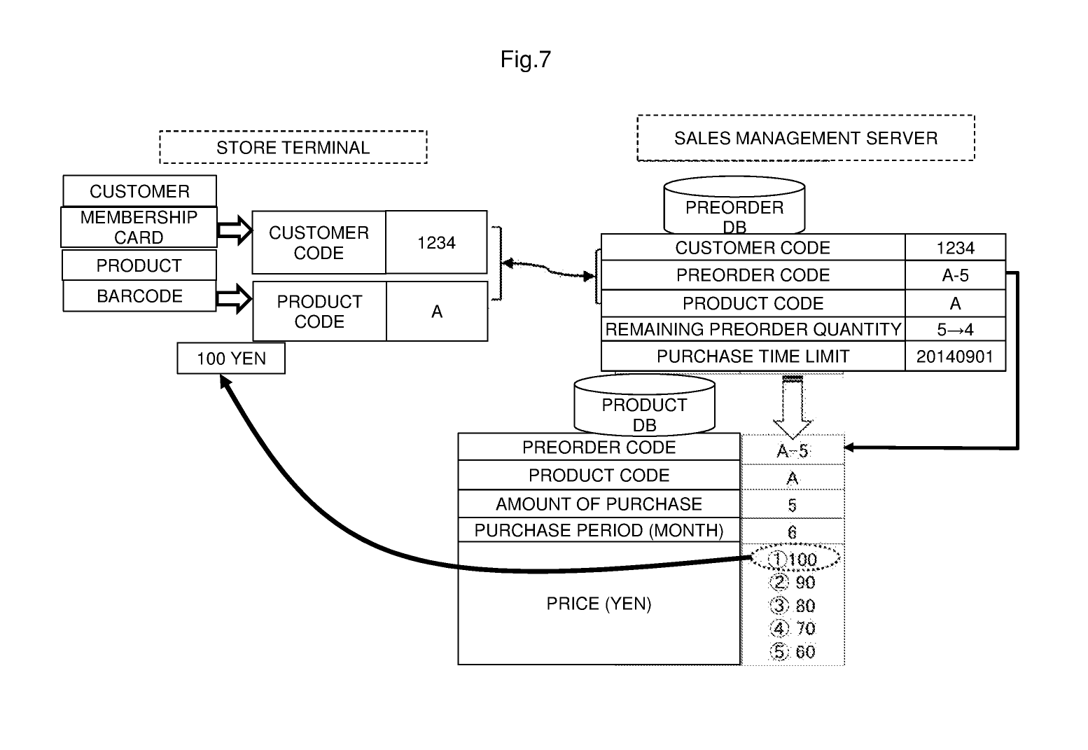

FIG. 7 shows a flow in an initial purchase of a product preordered by a customer in a state in which the information about the preorder of the “bulk purchase” is stored in the preorder information storing unit 16 (the preorder database) as in FIG. 6. The customer who wants to purchase a product preordered for the “bulk purchase” presents a membership card and a product at a register provided with the register terminal 30. At the register terminal 30, a membership code is read from the membership card and a product code such as a JAN code is read from a barcode stuck to the product or the like, and a purchase request with these codes designated is transmitted to the sales management server 10.

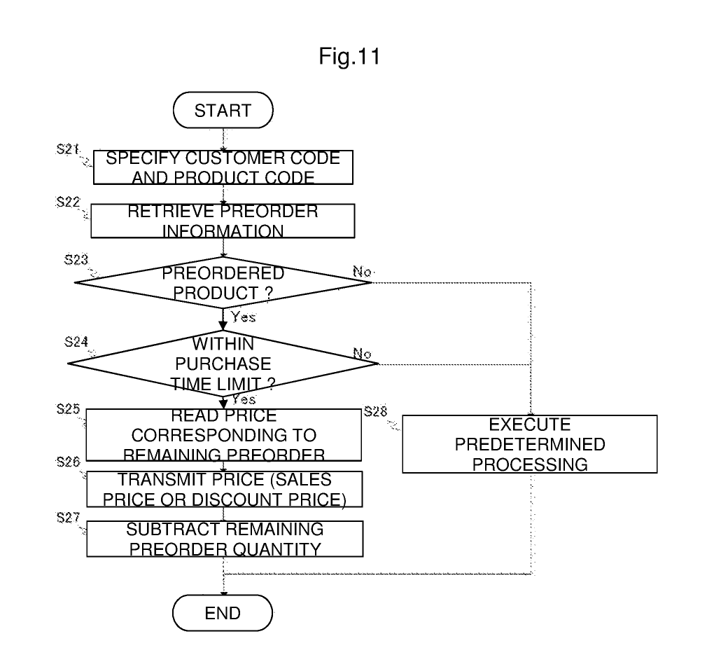

In the sales management server 10 accepting the purchase request, the purchase request processing unit 13 is activated so that the processing shown in the flowchart of FIG. 11 is executed. If a customer code and a product code are specified based on the purchase request received from the register terminal 30 (S21), the preorder information storing unit 16 (the preorder database) is retrieved (S22) and it is confirmed whether a product to be a target of the purchase request is relevant to a product preordered by the customer (S23).

If it is confirmed that the product is preordered, it is confirmed whether a purchase time limit passes in contrast of a purchase time limit included in the relevant preorder information with a current date (S24). If the product has no preorder or if the product has a preorder and the purchase time limit passes, a processing method is not particularly restricted but a predetermined processing is executed, for example, a notice indicative of a regular price is returned to the register terminal 30 (S28).

If it is confirmed that the product is preordered and the purchase time limit does not pass, the remaining preorder quantity on that point of time is confirmed based on the preorder information and a selling price corresponding to the remaining preorder quantity is read (S25) and is transmitted to the register terminal 30 (S26). Referring to the selling price corresponding to the remaining preorder quantity, as shown in the example of FIG. 7, the selling price corresponding to the remaining preorder quantity may be read from the product information storing unit 15 (the product database) with the preorder code set to be the key on the assumption that the preorder information includes the preorder code for identifying the pattern of the purchase condition or each preorder information to be stored in the preorder information storing unit 16 (the preorder database) may include and read the selling price corresponding to the remaining preorder quantity as described above.

Moreover, it is also possible to employ a structure in which a discount price from a regular price is transmitted to the register terminal 30 in place of a selling price of a product and a selling price is calculated on the register terminal 30 side. In this case, it is preferable that the discount price corresponding to the remaining preorder quantity should be stored in the product information storing unit 15 (the product database) or the preorder information storing unit 16 (the preorder database) in place of the selling price corresponding to the remaining preorder quantity.

Subsequently, the remaining preorder quantity included in the preorder information stored in the preorder information storing unit 16 (the purse preorder database) is updated with the present amount of sales decreased (S27). In addition, a purchase history of the product of the customer may be written to the customer information storing unit 14 (the customer database). In the example of FIG. 7, on the assumption that a single preordered product A is purchased, the remaining preorder quantity is updated from “5” to “4”. In the case in which a plurality of products A is purchased, a selling price corresponding to how many products have already been purchased (that is, how many products for the remaining preorder quantity) is read and transmitted to the register terminal 30, and furthermore, the remaining preorder quantity is subtracted corresponding to the amount of sales.

Moreover, it is also possible to employ a structure in which the initial amount of preorder and the amount of sales are memorized in the preorder information stored in the preorder information storing unit 16 (the preorder database) in place of the remaining preorder quantity. Also in this case, the remaining preorder quantity can be specified by subtracting the amount of sales from the amount of preorder. Therefore, the same processing can be performed. After the sales, the amount of sales is updated in place of the remaining preorder quantity.

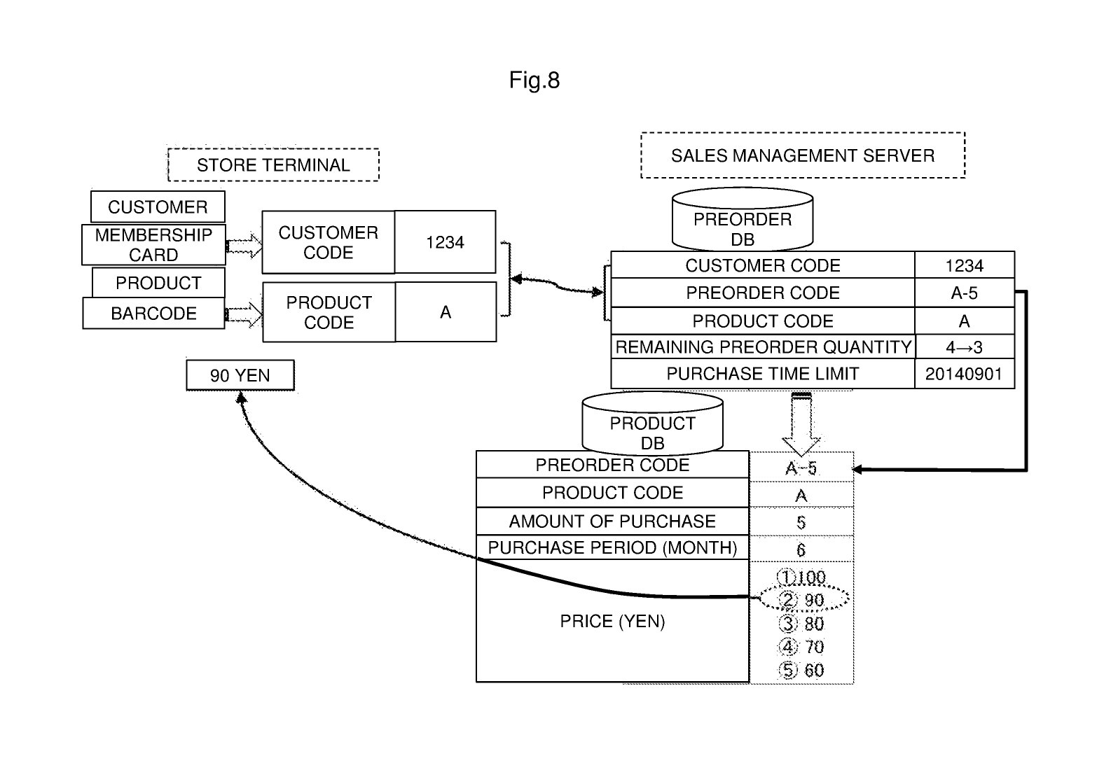

FIG. 8 shows a flow in the purchase of a second one of the preordered products. Since the remaining preorder quantity is decreased into “4”, a selling price corresponding to the remaining preorder quantity, that is, “90 YEN” to be a selling price for a second one of the products is returned to the register terminal 30 so that the remaining preorder quantity is updated into “3”.

The description has been given on the assumption that necessary information for determining the selling price corresponding to the “bulk purchase” such as the purchase condition or the purchase time limit, for example, the selling price to be changed corresponding to the remaining preorder quantity is held on the sales management server 10 side. In the present invention, however, it is also possible to employ a structure in which these information are returned to the terminal side to be operated by the customer in the registration of the preorder and are written to a storage medium such as an IC chip of a membership card held by the customer or these information are changed into a two-dimensional code which is output as a coupon ticket and a communication with the sales management server 10 is not performed but necessary information is read from the membership card or the coupon ticket to determine the selling price in the register terminal 30 in the purchase of the preordered product.

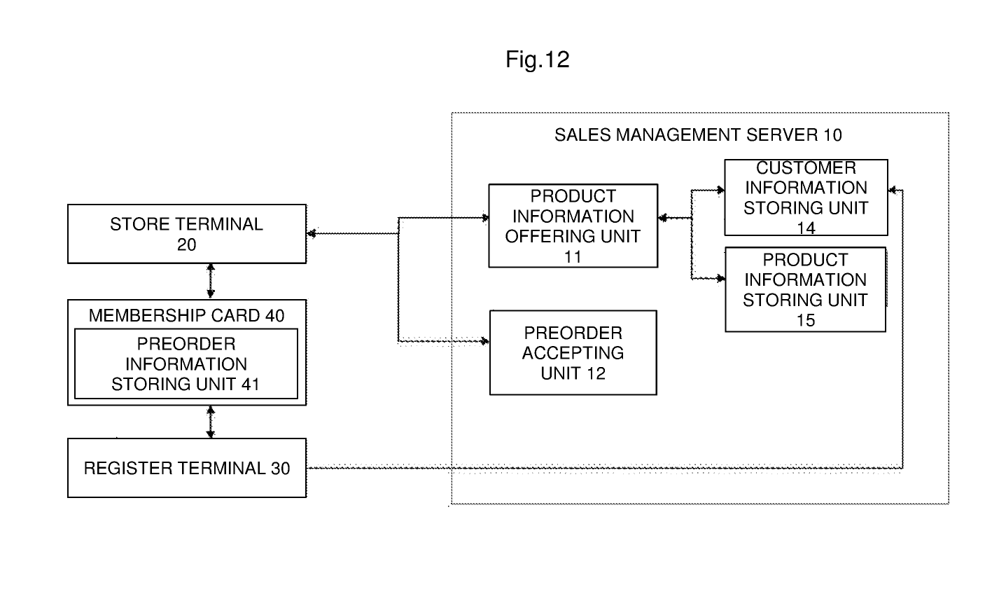

FIG. 12 shows an example of a structure in the case in which necessary preorder information for determining the selling price corresponding to the “bulk purchase” is written to a storage medium such as an IC chip of a membership card as a third embodiment. In the third embodiment, the preorder information such as the purchase condition or the purchase time limit, for example, the selling price to be changed corresponding to the remaining preorder quantity to be stored in the preorder information storing unit 16 in the first embodiment is stored in the preorder information storing unit 41 of the membership card 40. Although the example of the preorder information according to the first embodiment is shown in FIG. 1 and FIGS. 6 to 8, they are stored in a membership card to be issued for each member which is a customer in the third embodiment. Therefore, a customer code for specifying a customer does not need to be included in each preorder information.

A processing flow according to the third embodiment will be considered with reference to the flowchart of FIG. 10. If the bulk purchase is selected in S12, a processing for transmitting the preorder information to the store terminal 20 and writing the preorder information to the preorder information storing unit 41 of the membership card 40 through the store terminal 20 is executed in place of the processing (S14) for registering the preorder information in the preorder information storing unit 16.

Moreover, a flow in the purchase of a product by a customer will be considered with reference to the flowchart of FIG. 11. This processing is executed in the register terminal 30 or the membership card 40, and the preorder information stored in the preorder information storing unit 41 of the membership card 40 is retrieved with a product code set to be a key in S22. In S26, moreover, a selling price or a discount price is determined and output to the register terminal 30. In S27, furthermore, there is subtracted the remaining preorder quantity stored in the preorder information storing unit 41 of the membership card 40.

Referring to which of the register terminal 30 and the membership card 40 is to execute these calculation processings, variations are present depending on a calculation processing function provided in the membership card 40. For example, calculation processings related to the determination of the selling price or the like or the update of the remaining preorder quantity may be executed by a CPU and a memory which are provided in the membership card 40 or these calculating processings may be performed by the register terminal 30 and the membership card 40 may be simply utilized as a storage medium for the preorder information or the like. Moreover, the retrieval processing corresponding to S22 does not directly retrieve the preorder information storing unit 41 of the membership card 40 but may read the preorder information stored herein onto the register terminal 30 and temporarily store them therein and may set, to be a retrieval target, the information stored in the preorder information storing unit 41 of the membership card 40 and stored temporarily in the register terminal 30.

As described above, in the third embodiment, the sales management device according to the present invention can be supposed by variations constituted by one of the register terminal 30 and the membership card 40 or both of them.

### EXPLANATION OF DESIGNATION

10 sales management server
11 product information offering unit
12 preorder accepting unit
13 purchase request processing unit
14 customer information storing unit
15 product information storing unit
16 preorder information storing unit
20 store terminal
30 register terminal
40 membership card
41 preorder information storing unit

1-12. (canceled)

13. A sales management device for managing sales of a predetermined amount of preordered products or services with the same product or service set to be a target,
the device comprising:
storing means for storing preorder information including a customer code for identifying a customer performing preorder, a product code for identifying the preordered product or service, a remaining preorder quantity obtained by subtracting an amount of sales after the preorder from a preorder quantity determined in the preorder of the preordered product or service, and information about a purchase condition for the product or the service to change a selling price every decrease in the remaining preorder quantity in relation to the predetermined amount of preordered products or services with the same product or service set to be the target;
receiving means for receiving a request for purchasing a product or a service for which a customer code for identifying a customer and a product code for identifying a product or a service are designated from a terminal device connected through a network;
deciding means for retrieving the storing means by setting, as a key, a combination of the customer code and the product code which are designated for the purchase request received by the receiving means and deciding whether sales corresponding to the preorder can be performed based on presence of the preorder having the remaining preorder quantity;
transmitting means for determining a selling price or a discount price of the product or the service corresponding to the purchase request in accordance with the purchase condition stored in the storing means and transmitting the selling price or the discount price to the terminal device when it is decided by the deciding means that the sales corresponding to the preorder can be performed; and
updating means for updating the remaining preorder quantity included in the preorder information stored in the storing means by subtracting the amount of the product or service decided to be freely sold corresponding to the preorder by the deciding means.

14. The sales management device according to claim 13, wherein the storing means stores preorder information including information about a preorder quantity determined in a preorder of a preordered product or service and a sales quantity acquired after the preorder, and a purchase condition of a product or service having a selling price changed every decrease in a remaining preorder quantity obtained by subtracting the sales quantity from the preorder quantity in place of storage of the remaining preorder quantity and the preorder information,
the deciding means decides whether sales for a preorder portion can be performed based on presence of a preorder having a remaining preorder quantity obtained by subtracting the sales quantity acquired after the preorder from the preorder quantity determined in the preorder, and
The updating means updates the sales quantity acquired after the preorder included in the preorder information stored in the storing means by adding a quantity of products or services decided to be able to be sold as a preorder portion by the deciding means.

15. The sales management device according to claim 13, wherein a condition for reducing a unit selling price of the product or the service every decrease in the remaining preorder quantity is set to the purchase condition to be stored in the storing means.

16. The sales management device according to claim 14, wherein a condition for reducing a unit selling price of the product or the service every decrease in the remaining preorder quantity is set to the purchase condition to be stored in the storing means.

17. The sales management device according to claim 13, wherein the preorder information to be stored in the storing means includes information about a purchase time limit that the sales corresponding to the preorder can be performed, and
the deciding means decides whether the sales corresponding to the preorder can be performed based on presence of the remaining preorder quantity and presence of the preorder without the purchase time limit expired.

18. The sales management device according to claim 14, wherein the preorder information to be stored in the storing means includes information about a purchase time limit that the sales corresponding to the preorder can be performed, and
the deciding means decides whether the sales corresponding to the preorder can be performed based on presence of the remaining preorder quantity and presence of the preorder without the purchase time limit expired.

19. The sales management device according to claim 13, wherein the storing means stores, as the purchase condition included in the preorder information, information to be a key for specifying a selling price or a discount price to be determined for each remaining preorder quantity in relation to a product or a service to be specified by a product code stored in a predetermined storing unit.

20. The sales management device according to claim 13, wherein the storing means stores, as a purchase condition included in the preorder information, a selling price or a discount price of a product or a service to be determined for each remaining preorder quantity.

21. A sales management method for managing sales of a predetermined amount of preordered products or services with the same product or service set to be a target,
a computer having storing means for storing preorder information including a customer code for identifying a customer performing preorder, a product code for identifying a preordered product or a service, a remaining preorder quantity obtained by subtracting an amount of sales after the preorder from an amount of preorder determined in the preorder of the preordered product or service, and information about a purchase condition for the product or the service to change a selling price every decrease in the remaining preorder quantity in relation to the predetermined amount of preordered products or services with the same product or service set to be the target,
the method comprising:
a receiving step of causing the computer to receive a request for purchasing a product or a service for which a customer code for identifying a customer and a product code for identifying a product or a service are designated from a terminal device connected through a network;
a deciding step of causing the computer to retrieve the storing means by setting, as a key, a combination of the customer code and the product code which are designated for the purchase request received at the receiving step and to decide whether sales corresponding to the preorder can be performed based on presence of the preorder having the remaining preorder quantity;
a transmitting step of causing the computer to determine a selling price or a discount price of the product or the service corresponding to the purchase request in accordance with the purchase condition stored in the storing means and to transmit the selling price or the discount price to the terminal device when it is decided at the deciding step that the sales corresponding to the preorder can be performed; and
an updating step of causing the computer to update the remaining preorder quantity included in the preorder information stored in the storing means by subtracting the amount of the products or services decided to be freely sold corresponding to the preorder at the deciding step.

22. The sales management method according to claim 21, wherein the storing means stores preorder information including information about a preorder quantity determined in a preorder of a preordered product or service and a sales quantity acquired after the preorder, and a purchase condition of a product or service having a selling price changed every decrease in the remaining preorder quantity obtained by subtracting the sales quantity from the preorder quantity in place of storage of the remaining preorder quantity and the preorder information,
at the deciding step, the computer decides whether sales for a preorder portion can be performed based on presence of a preorder having the remaining preorder quantity obtained by subtracting the sales quantity acquired after the preorder from the preorder quantity determined in the preorder, and
At the updating step, the computer updates the sales quantity acquired after the preorder included in the preorder information stored in the storing means by adding a quantity of the products or services decided to be able to be sold as the preorder portion at the deciding step.

23. A sales management device for managing sales of a predetermined amount of preordered products or services with the same product or service set to be a target,
the device comprising:
accepting means for accepting a product code for identifying a product or a service to be purchased by a customer;
deciding means for retrieving information stored in a storing unit of a storing medium for storing preorder information including a product code for identifying a preordered product or service, a remaining preorder quantity obtained by subtracting an amount of sales after the preorder from an amount of preorder determined in the preorder of the preordered product or service, and information about a purchase condition for the product or the service to change a selling price every decrease in the remaining preorder quantity and deciding whether sales corresponding to the preorder can be performed based on presence of the preorder having the remaining preorder quantity in relation to the predetermined amount of preordered products or services with the same product or service set to be the target by setting the product code accepted by the accepting means as a key;
determining means for determining a selling price or a discount price of a product or a service to be purchased by the customer in accordance with the purchase condition stored in the storing unit when it is decided by the deciding means that the sales corresponding to the preorder can be performed; and
updating means for updating the remaining preorder quantity included in the preorder information stored in the storing unit by subtracting the amount of the products or services decided to be enable sold corresponding to the preorder by the deciding means.

24. A sales management device for managing sales of a predetermined amount of preordered products or services with the same product or service set to be a target,
the device comprising:
accepting means for accepting a product code for identifying a product or a service to be purchased by a customer;
deciding means for retrieving information stored in a storing unit of a storing medium for storing preorder information including a product code for identifying a preordered product or service, an amount of preorder determined in the preorder of the preordered product or service and an amount of sales after the preorder, and information about a purchase condition of the product or the service to change a selling price every decrease in a remaining preorder quantity obtained by subtracting the amount of sales from the amount of preorder and deciding whether sales corresponding to the preorder can be performed based on presence of the preorder having the remaining preorder quantity in relation to the predetermined amount of preordered products or services with the same product or service set to be the target by setting the product code accepted by the accepting means as a key;
determining means for determining a selling price or a discount price of a product or a service to be purchased by the customer in accordance with the purchase condition stored in the storing unit when it is decided by the deciding means that the sales corresponding to the preorder can be performed; and
updating means for updating the amount of sales after the preorder included in the preorder information stored in the storing unit by adding the amount of the products or services decided to be enable sold corresponding to the preorder by the deciding means.
